(19) United States
(12) Patent Application Publication
(10) Pub. No.: US 2011/0043403 A1
(43) Pub. Date: Feb. 24, 2011

(54) MILLIMETER WAVE CAMERA WITH IMPROVED RESOLUTION THROUGH THE USE OF THE SAR PRINCIPLE IN COMBINATION WITH A FOCUSING OPTIC

(75) Inventor: Torsten Löffler, Glashutten (DE)

Correspondence Address: DRINKER BIDDLE & REATH (DC), 1500 K STREET, N.W., SUITE 1100, WASHINGTON, DC, 20005-1209, US

(73) Assignee: SYNVIEW GMBH, BAD HOMBURG (DE)

(21) Appl. No.: 12/918,961

(22) PCT Filed: Feb. 11, 2009
(86) PCT No.: PCT/EP09/51538

§ 371 Date: Nov. 9, 2010

(30) Foreign Application Priority Data
Feb. 27, 2008 (DE) 10-2008-011-350.6

(51) Int. Cl. G01S 13/90; G01J 5/02

(52) U.S. Cl. 342/25 A; 250/340

(57) ABSTRACT

The present invention concerns an apparatus for and a method of imaging an object by means of electromagnetic very high frequency radiation. The state of the art discloses systems for and methods of imaging with a synthetic aperture, which distinguish the signals emitted by individual transmitting antennas from each other after reflection thereof by an object upon reception on a plurality of receivers. In that respect systems are known which for that purpose use a row-like arrangement of transmitters and receivers, wherein an object is rotated on a motor-driven platform in front of the transmitter or receiver row. In comparison the object of the present invention is to provide an apparatus for and a method of imaging an object, which make it possible to achieve as high a resolution as possible with as low a number of transmitters and receivers as possible. To attain that object in accordance with the invention there is proposed an apparatus for imaging an object by means of electromagnetic very high frequency radiation comprising at least two receivers for the very high frequency radiation, wherein the receivers are arranged in a row configuration, a control operating the receivers in such a way that they produce a synthetic aperture image in a direction parallel to the row and an imaging optical means which is so adapted that it causes optical imaging only in planes substantially perpendicular to the row.

The present invention concerns an apparatus for and a method of imaging an object by means of electromagnetic very high frequency radiation.

The terahertz frequency range (THz) is one of the last ‘dark’ frequency ranges in the electromagnetic spectrum, that is to say hitherto it has only been possible with difficulty to obtain radiation sources and receivers for that frequency range. Hitherto therefore the applications of electromagnetic radiation in that frequency range are restricted to research-related fields such as for example radioastronomy or material sciences. In that respect the THz frequency range offers considerable advantages over other frequency ranges in the electromagnetic spectrum:
many optically opaque materials are transparent in the THz frequency range,
THz radiation is non-ionising and is therefore considered to be safe in the biomedical area,
given rotary, translatory or vibronic molecule excitations have a resonance frequency in the THz frequency range,
THz radiation affords essential items of information about charge carrier dynamics, in particular in nanostructures, which play an essential part in future photonic and electronic components,
THz radiation exhibits a low degree of scatter compared to optical frequencies and is therefore suitable in particular for use in industrial environments in which for example dust formation increasingly occurs, and
if communication systems are considered then higher frequencies permit greater transmission band widths.

The attempt has been made for some time now to make the THz frequency range accessible to imaging applications, in particular in medical technology and in security technology, for example for identity checks. In that respect methods of so-called synthetic imaging are frequently employed.

The principle of synthetic imaging which is frequently also referred to as imaging with a synthetic aperture is that the photograph of an antenna or an objective with a large aperture is replaced by a multiplicity of time-successive photographs of a moving antenna or a moving objective with a small aperture or also by a multiplicity of time-successive photographs of a multiplicity of stationary antennas or stationary objectives with a small aperture.

The best-known synthetic imaging system is the so-called Synthetic Aperture Radar (for brevity: SAR). In that situation the transmitting and receiving antennas of a radar system fitted for example on an aircraft are moved past an object. In the course of that movement the object is irradiated with a variable angle of view and correspondingly recorded. If the path of the transmitting and receiving antennas is not sufficiently known the aperture of a large antenna can be synthesised from the intensity and phase position of the high frequency signal emitted by the transmitting antenna and reflected back into the receiving antenna by that object and thus a high level of positional resolution can be achieved in the direction of movement of the antenna. By means of the recorded data of the reflected radar signal, calculated for each location irradiated by the transmitting antenna in the course of the fly-past is a synthetic antenna specific thereto, the angle resolution of which in azimuth terms is so selected that the geometrical resolution in the direction of flight or movement is the same for all distances considered.

For stationary applications, for example for monitoring people by means of very high frequency radiation in the MHz and GHz frequency range, systems are known which, instead of a single pair of transmitting and receiving antennas which are in motion relative to the object, use a multiplicity and transmitting and receiving antennas which image the object at different angles and the signals of which are evaluated in accordance with the SAR principle. In that case either the transmitting antennas themselves or separate receiving antennas can be used to receive the waves which are reflected by or transmitted through the object. To achieve spatial resolution which is as good as possible, the signal emitted by a single transmitting antenna is received with a multiplicity of receiving antennas.

In that respect the state of the art, for example WO 2006/036454 A2 discloses systems for and methods of imaging with a synthetic aperture, which distinguish the signals emitted by the individual transmitting antennas from each other in accordance with their reflection by an object or their transmission through an object upon reception on to a multiplicity of receivers. In that situation the individual transmitting antennas emit their signals which are all at the same frequency in succession in respect of time, that is to say signal emission from the individual transmitters is effected serially. In those methods the signal received at each receiver can be uniquely associated with a transmitter at any moment in time, but serial activation of the transmitters entails a comparatively long measurement time.

The system known from WO 2006/036454 A2 uses a row-like arrangement of transmitters and receivers, wherein for scanning a three-dimensional object it is rotated on a motor-driven platform in front of the transmitter or receiver row respectively. In that way the surface of a three-dimensional object is completely scanned during the measurement operation as occurs in the case of a conventional aircraft-borne SAR system by virtue of the aircraft flying past over the surface of the ground. In alternative systems, instead of the object to be detected, the transmitter or receiver row is rotated about the object in order in that way to permit fully synthetic detection of the object.

Yet other systems use two-dimensional arrangements of transmitters and receivers in the manner of an array in order thereby to achieve fully synthetic imaging of a three-dimensional object. Such systems however require a large number of transmitters and receivers in both dimensions to afford adequate resolution.

In comparison the object of the present invention is to provide an apparatus for and a method of imaging an object by means of electromagnetic very high frequency radiation which make it possible to achieve as high a resolution as possible with as low a number of transmitters and receivers as possible and possibly to avoid rotation of the object to be imaged.

At least one of the aforementioned is attained by apparatus for imaging an object by means of electromagnetic very high frequency radiation comprising at least two receivers for the very high frequency radiation, wherein the receivers are so arranged that they form a row, a control which is so adapted that the receivers are so operable that they produce imaging with a synthetic aperture in a direction parallel to the row, and an imaging optical means which is so adapted that it produces optical imaging only in planes substantially perpendicular to the row.

The apparatus according to the invention represents a hybrid system which in a first direction or dimension produces conventional optical imaging by means of an imaging optical means while in a second direction or dimension perpendicular thereto the advantages of imaging with a synthetic aperture are enjoyed.

The reference to very high frequency radiation in accordance with the present invention is used to denote electromagnetic radiation in a frequency range of between 800 MHz and 10 THz, that is to say in an enlarged THz frequency range. Preferably the frequencies used for imaging are in a range of between 30 GHz and 1 THz and are particularly preferably at about 100 GHz. At those frequencies large differences occur in the reflection and transmission characteristics of various materials which play a part for example in people monitoring. Metal, for example the surface of a firearm or stabbing weapon has high reflectivity in that frequency range while biological material, for example the surface of the skin of the person bearing the weapon, has a pronounced absorption window in that frequency range.

In an embodiment the apparatus according to the invention has at least a first and a second radiation source for electromagnetic very high frequency radiation which together with the receivers are so arranged that they form a row of radiation sources and receivers. In that case in an embodiment illumination of the object with the radiation emitted by the radiation sources is effected with the same imaging optical means which serves to image the radiation on to the receivers.

In that respect the apparatus according to the invention is not limited to two radiation sources or receivers but in embodiments has more than two transmitters and/or receivers.

The reference to a row in accordance with the present invention denotes an arrangement of radiation sources and/or receivers in which the radiation sources and/or receivers are arranged along a straight line. That means that the arrangement of radiation sources and/or receivers in one direction is of a greater extent than in the direction perpendicular thereto. A row in accordance with the present invention however does not exclude each column of the row having more than one radiation source or receiver. In other words, for example arrangements of 2×4 or 4×20 radiation sources or receivers are also considered as a row as long as the arrangements in one direction are of a greater extent than in the direction perpendicular thereto.

When the description of the present invention refers to the fact that the imaging optical means is so adapted that it produces optical imaging only in planes substantially perpendicular to the row, that means that for example beams incident on the imaging optical means in parallel relationship are so deflected only in planes perpendicular to the row that they are focused on to a line behind the imaging optical means.

In an embodiment of the invention the first radiation source is adapted to emit a first uniquely identifiable electromagnetic signal and the second radiation source is adapted for emitting a second uniquely identifiable electromagnetic signal, and wherein the two receivers are so adapted that each of them receives the first and second signals substantially simultaneously.

In an embodiment of the invention the electromagnetic signals emitted by the individual radiation sources are uniquely encoded by means of the frequency of the emitted signals, that is to say they are to be distinguished from each other by their frequency. As in an embodiment there are not two radiation sources with an identical frequency in respect of the respectively emitted electromagnetic signal, each signal received by a receiver can be uniquely associated with a single radiation source.

As each of the receivers simultaneously receives the first and the second signals a large aperture can be synthesised from the received signals in a short time, in the direction of the row of radiation sources and/or receivers, and an image in row form can be computed with a high level of resolution.

In accordance with this embodiment the reference to the frequency of the electromagnetic signals is used to denote their carrier frequency and not for example their modulation frequency.

As an alternative to the described frequency encoding unique identifiability of the electromagnetic signals emitted by the individual radiation sources can also be effected by unique channel encoding at the same carrier frequency, as is known from mobile radio and communication technology.

In a further embodiment the first and second receivers are coupled in phase-locked relationship to each other, irrespective of whether the radiation sources and the receivers are or are not coupled in phase-locked relationship. In that way detection of the electromagnetic signals can be effected by interferometric means, in which case interferometric algorithms which take account of the phase differences of the electromagnetic signals between the individual receivers are used for image production.

In addition in an embodiment the first and second receivers are phase-coupled to the radiation sources.

The apparatus according to the invention is suitable in that respect in particular for emitting and receiving an electromagnetic continuous-wave signal (CW signal). In an embodiment the frequency of the emitted electromagnetic continuous-wave signals can be kept constant over the measurement time. Alternatively the frequency of the signals can be altered over the measurement time, provided that at no moment in time do two signals have the same frequency or the same uniquely identifiable signature in order over the entire measurement time to permit unique association of the individual signals received by the receivers with the respective radiation sources.

In an embodiment emission of the first and second signals is effected substantially simultaneously. By virtue of the unique identifiability of the electromagnetic signals emitted by the individual radiation sources in spite of the signals being emitted at the same time they can be uniquely associated with the emitting radiation sources.

Computation of the image in line form in the direction of the arrangement in rows of radiation sources and/or receivers is effected by means of algorithms as are typically used for imaging methods with a synthetic aperture or for interferometric radar imaging or interferometric radioastronomy. In that respect an embodiment using the principle of synthetic imaging provides that the signals received simultaneously by at least two receivers, from a single radiation source, are processed to provide a first synthetic image of a single virtual antenna with a large synthetic aperture. In that case then that production of a synthetic image is also effected simultaneously for all signals emitted by the further radiation sources.

Suitable imaging algorithms are known for example from the book by Mehrdad Soumekh ‘Fourier Array Imaging’, Prentice Hall, PTR, edition: January 1994, ISBN-10:0130637696, the content of which insofar as it concerns the imaging algorithms is incorporated herein in its entirety by reference. The methods of producing an image of an object, described herein as imaging with a synthetic aperture, are also referred to as holographic imaging or interference imaging at another location in the literature.

An embodiment which as described above has a first and a second radiation source, wherein the first radiation source is adapted to emit a first electromagnetic signal at a first frequency and wherein the second radiation source is adapted to emit a second electromagnetic signal at a second frequency, wherein the first and second frequencies are different from each other, and having at least two receivers which are so adapted that each thereof substantially simultaneously receives the first and second signals, is described in German patent application DE 10 2007 045 103.4. In particular the arrangement comprising the at least one first and second radiation sources and the at least two receivers can be found in the description of the above-specified laid-open specification, but in particular the claims. In that respect the disclosure of DE 10 2007 045 103 is incorporated herein by reference with its entire disclosure.

In an embodiment the imaging optical means has a cylindrical optical means. Such cylindrical optical means are in the ideal sense astigmatic, that is to say they produce optical images only in planes perpendicular to their cylinder axis. Such cylindrical optical means are therefore particularly suitable for use in apparatuses in accordance with the present invention as, when their cylinder axis extends substantially parallel to the row of radiation sources and/or receivers, they produce optical imaging in planes perpendicular to the row while in a direction parallel to their cylinder axis they do not have any imaging action.

The reference to cylindrical optical means in the sense of the present invention is used to denote optical means whose refractive interfaces or reflecting surfaces are formed by the peripheral surface of a cylinder or the inside surface of a hollow cylinder or of a surface segment therefrom. The main bodies for those cylindrical optical means preferably involve right cylinders whose peripheral or inside surfaces are perpendicular to the base surfaces, wherein the base surfaces or internal cross-sectional areas are formed preferably by circles or ellipses. Optical means with parabolic or hyperbolic surfaces are also included in accordance with the present invention among the cylindrical optical means as long as they are astigmatic.

In an embodiment the row of radiation sources and/or receivers is arranged at a first focal point of a hollow-cylindrical optical means. If in an embodiment of the invention the hollow-cylindrical optical means is of an elliptical internal cross-sectional area defining the configuration of the reflecting inside surface of the body then the cylindrical optical means has two focal points. If the cylindrical row of radiation sources and/or receivers is arranged in the first focal point so that the radiation sources and/or receivers point towards the reflecting surface of the hollow-cylindrical optical means then the electromagnetic radiation emitted by the radiation sources is focused by the elliptical mirror on to a line on the object. While the resolution of that imaging system in the direction perpendicularly to the arrangement of the row is achieved by the imaging itself, in a direction parallel to the row that involves a synthetic aperture which serves for image production in that direction.

Alternatively to the described elliptical or parabolic hollow mirrors the imaging optical means in embodiments of the invention can also be formed by cylindrical telescopes, for example cylindrical Cassegrain telescopes, Newtonian telescopes, Schmidt telescopes or hybrid forms thereof.

To be able to produce an image in the direction perpendicular to the row, in an embodiment of the invention the cylindrical optical means is pivotable about an axis parallel to the cylinder axis, that is to say also to the row of radiation sources and/or receivers. In that way an object can be scanned or rastered in a direction perpendicular to the row.

In a further embodiment in that respect it is not only the cylindrical optical means that is pivoted about an axis parallel to the cylinder axis, but also the row of radiation sources and/or receivers. In that case the axis of rotation or pivotal movement is preferably on the axis formed by the row of radiation sources and/or receivers.

As an alternative to pivotal or rotary movement of the components of the system, a movement of the focal line of the imaging optical means can also be effected in embodiments of the invention by a translatory movement of one or more elements of the apparatus. For example the row of radiation sources and/or receivers, the cylindrical optical means, the primary mirror or the primary mirrors can be displaced relative to each other in a direction perpendicular to the direction of the row of radiation sources and/or receivers.

In an alternative embodiment the cylindrical optical means, preferably a cylindrical hollow mirror, has a parabolic base surface. In that respect in the case of a hollow mirror having the parabolic base surface, that base surface is meant which defines the shape of the inside surface of the hollow mirror.

An embodiment of the invention has an arrangement in which the hollow cylinder mirror forms a primary mirror of the imaging optical means and the imaging optical means additionally has a secondary mirror. In that respect in an embodiment the secondary mirror is arranged at the first focal point of the hollow-cylindrical optical means. Such an arrangement makes it possible for the electromagnetic radiation emitted by the apex point of the hollow-cylindrical primary mirror to firstly be incident on the secondary mirror, from there to be reflected on to the hollow-cylindrical primary mirror and then to be focused by the hollow-cylindrical primary mirror in one dimension on the object.

In that respect it is desirable if in an embodiment of the invention the secondary mirror is pivotable about an axis substantially parallel to the cylinder axis of the hollow-cylindrical primary mirror so that the focal line produced by the primary mirror can be displaced in a direction perpendicular to the cylinder axis, which makes it possible also to scan an object in that direction and to produce a complete image of its surface. In that respect in an embodiment the imaging optical means has a plurality of secondary mirrors which are preferably formed by the peripheral surfaces of a prismatic body. Such an arrangement having a plurality of secondary mirrors can produce a high scanning rate in a direction perpendicular to the cylinder axis upon rotation of the plurality of secondary mirrors about an axis parallel to the cylinder axis.

In that respect in embodiments of the present invention the secondary mirror does not have to have a flat surface but it can also be of a curved configuration.

In a further embodiment of the invention no movement of the imaging optical means is involved and instead an object is moved past the measurement system. For that purpose for example the object can be linearly moved by means of a conveyor belt or can be rotated by means of a turntable. In the particular case of monitoring people, an embodiment of the invention provides that the person to be checked moves independently past the measurement system or turns independently in front of the measurement system whereby it is also possible to dispense with actively moving components of the measurement system.

In a further embodiment the apparatus according to the invention has a device for altering the focal length of the imaging optical means. Such a device makes it possible to achieve sharp images of a three-dimensional object even with an imaging optical means with a low level of sharpness in depth.

In an embodiment the device for altering the focal length of the imaging optical means has elements which cause an alteration in at least a spacing between the elements of the apparatus. Such an element is for example a linear displacement means which makes it possible for a component of the apparatus to be moved relative to another, driven by motor means. In particular the spacing between the row of radiation sources and/or receivers and the secondary mirror or the primary mirror or the spacing between the primary mirror and the secondary mirror can be altered to achieve an alteration in the focal length.

In an embodiment of the invention the device for altering the focal length of the imaging optical means is formed by a plurality of secondary mirrors rotatable about an axis of rotation, the secondary mirrors being so adapted that the spacings of the secondary mirrors from the axis of rotation are different from each other. In that way upon a rotary movement of the plurality of secondary mirrors about the axis of rotation, it is not just the focal line of the imaging optical means that is pivoted in a direction perpendicular to the row of radiation sources and/or receivers, but each of the secondary mirrors involves a different spacing from the first focal point of the primary mirror so that the position of the focal line depends on which of the secondary mirrors is just being used for the imaging process and what tilt it involves. In that way, during scanning of the surface of an object, the focal length of the imaging optical means can be scanned through in discrete steps and sharp imaging of the object can be achieved over a depth substantially equal to the difference between the spacings of the secondary mirror arranged closest to the axis of rotation and the secondary mirror most remote from the axis of rotation.

In a further embodiment in that respect the secondary mirrors have different radii of curvature so that they involve a different focal length which influences the total focal length of the imaging optical means.

Further advantages, features and possible uses of the present invention will be apparent from the description hereinafter of an embodiment and the related Figures.

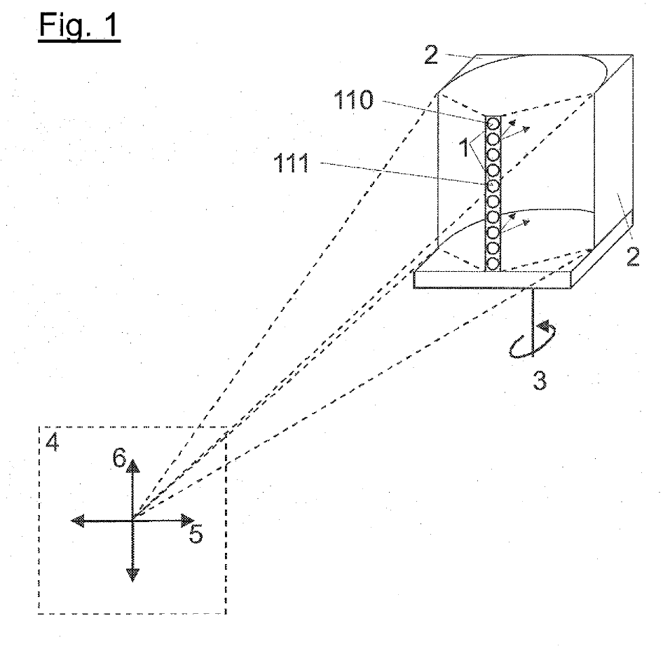

FIG. 1 shows a three-dimensional view of a first embodiment of the apparatus according to the invention,

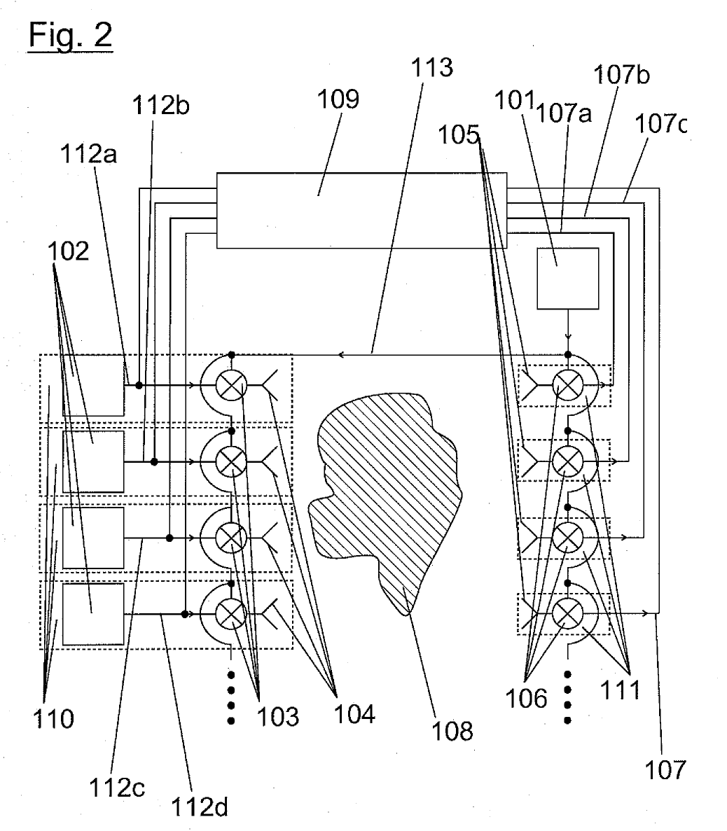

FIG. 2 diagrammatically shows the structure and the circuitry of radiation sources and receivers in an embodiment of the invention,

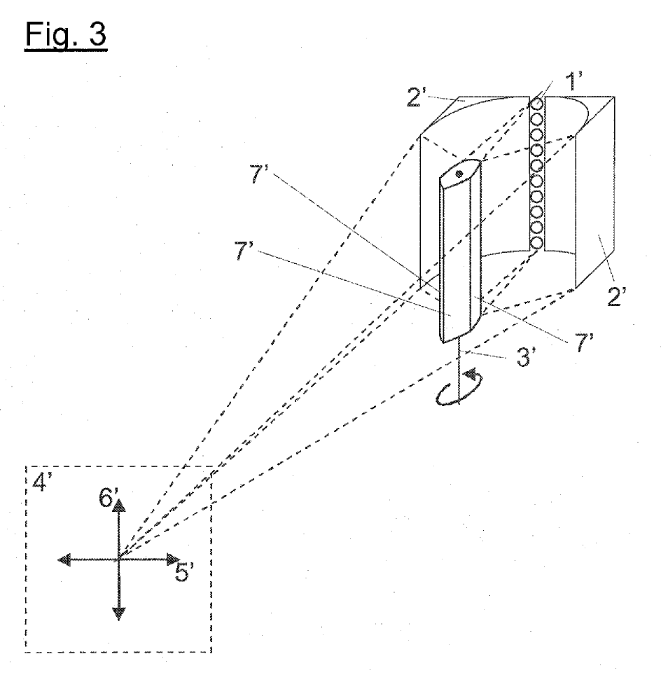

FIG. 3 shows a three-dimensional view of an alternative embodiment of the apparatus according to the invention, and

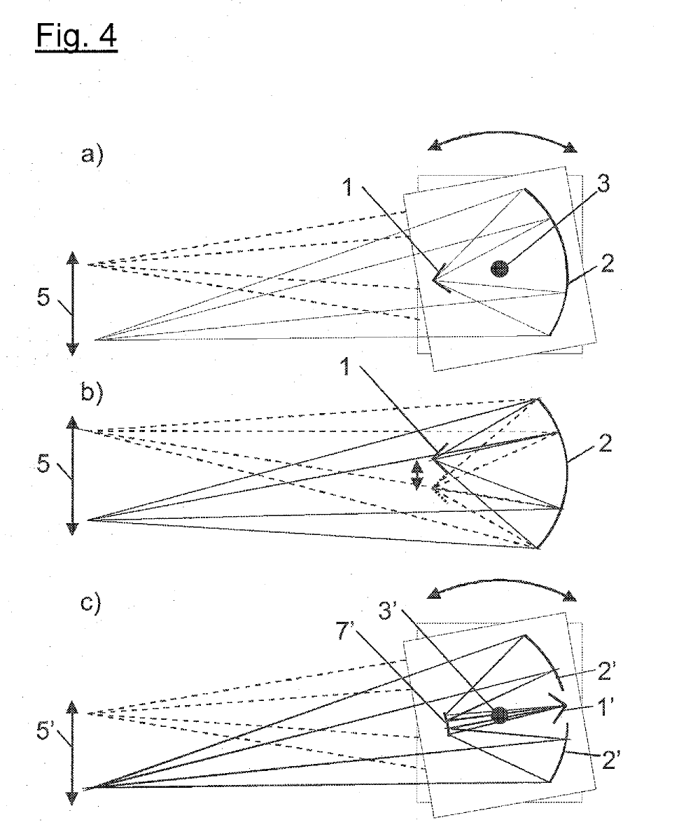

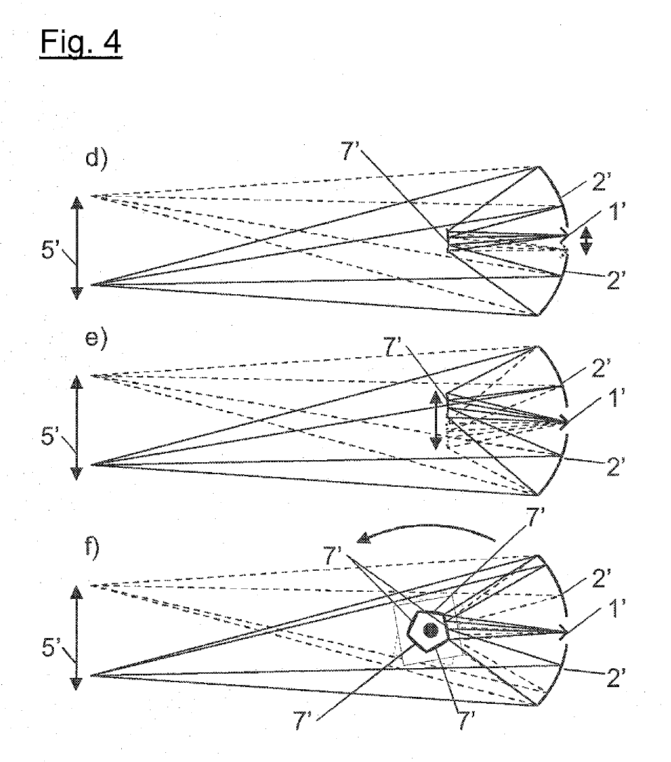

FIGS. 4a) through f) show diagrammatic views on to various embodiments of the present invention.

FIG. 1 shows a first embodiment of the apparatus according to the invention with a row-shaped arrangement 1 comprising a plurality of radiation sources 110 and receivers 111 and a cylindrical hollow mirror 2. The reflecting inside surface of the hollow mirror 2 is defined by an ellipse in a plane perpendicular to the direction of the row 1. The row-shaped arrangement 1 has radiation sources 110 and receivers 111 arranged in an irregular succession in mutually juxtaposed relationship. In the illustrated embodiment the row has five radiation sources 110 and receivers 111 respectively. That affords a plurality of spacings between the emission and reception positions of the individual radiation sources and receivers. Thus good coverage in the k-space is already achieved with a low number of radiation sources and receivers in a dimension, that is to say in a direction, in mutually juxtaposed relationship, wherein k is the inverse wave vector. The perpendicular row-shaped array of radiation sources 110 and receivers 111 is arranged at a first focal point of the elliptical hollow-cylinder mirror 2. In a vertical direction, that is to say a direction parallel to the row 1, the mirror 2 is not curved so that, as in the case of a cylindrical lens, only astigmatic imaging is implemented in a plane perpendicular to the row 1.

In an embodiment which is an alternative thereto and which is not shown here the hollow-cylindrical mirror 2 could be replaced by a cylindrical lens. In that case the object would be arranged behind the lens as viewed from the row 1.

The object to be imaged is arranged approximately at the second focal point of the hollow mirror. The position of the object is indicated in FIG. 1 by the object plane 4. All object points disposed in the object plane 4, which are on a vertical line corresponding to the focal line of the cylindrical optical means 2, are imaged by means of the synthetic array 2 of radiation sources and receivers.

In that respect, synthetic focusing is effected in the vertical direction 6 by means of suitable algorithms allowing evaluation of the measured signal amplitudes and phases. If there is an item of transit time information, that is to say information about the phase position, it is also possible to effect reconstruction of the information about the spacing of the object from the row 1.

The fact that synthetic imaging is effected only in one dimension by means of the row-shaped array 1 of radiation sources and receivers means that the demands both on the number of transmitting elements 110 and receiving elements 111 and also the computing power for reconstruction of the imaged object surface in the object plane 4 are markedly reduced in comparison with fully synthetic systems. In addition the signal-to-noise ratio of the arrangement is markedly improved in comparison with a fully synthetic system which calculates a synthetic aperture in two directions in space as a marked gain in signal is achieved at least in one direction by virtue of imaging with the hollow mirror 2, in the horizontal direction 5.

To permit not just imaging of the object points disposed in a single focal line produced by the hollow mirror 2 in the horizontal direction 5, the arrangement comprising the row 1 and the hollow mirror 2 is pivotable about the axis of rotation 3. In that way the focal line can be pivoted in the object plane 4 in the horizontal direction 5 by pivotal movement of the arrangement comprising the row 1 and the hollow mirror 2. In that way the entire object arranged in the object plane 4 can be converted to a digital image by scanning.

FIG. 2 diagrammatically shows the structure of the row 1 of radiation sources 110 and receivers 111 of FIG. 1. The row 1 has five transmitters or radiation sources 110 and receivers 111 respectively. In this respect only four radiation sources 110 and receivers 111 are respectively explicitly illustrated in the diagrammatic view while the similar continuation of the system with further radiation sources and receivers is indicated by black dots.

In the illustrated embodiment an object 108 is arranged between the radiation sources 110 and the receivers 111 so that, depending on the respective position of the object 108 in relation to the radiation sources 110 and receivers 111, the radiation transmitted through the object 108 or reflected by the object 108 is detected by the receivers 111.

The system has a computer 109 for controlling the apparatus and for data acquisition or image generation.

Each radiation source 110 has a signal generator 102 for producing a transmitter intermediate frequency signal 112 as well as a mixer 103 and a transmitting antenna 104. In addition each radiation source 110 is connected to a signal generator 101 for producing a radio frequency signal 113 at a frequency of 30 GHz. The mixers 103 of each radiation source 110 serve to mix the radio frequency signal 113 with a corresponding transmitter intermediate frequency signal 112. The mixed signal produced in that case is emitted by the radiation source 110 by means of the transmitting antenna 104.

In the illustrated embodiment the mixers 103 are so-called single-side-band mixers which produce a signal which only contains the sum frequency from the frequency of the radio frequency signal 113 and the transmitter intermediate frequency signal 112. Each intermediate signal 112a, 112b, 112c, 112d . . . produced by the signal generators 102 of the radiation sources 110 is of a frequency different from the other intermediate frequencies. In the illustrated embodiment the first intermediate frequency 112a is 2 MHz, the second intermediate frequency 112b is 4 MHz, 112c is 6 MHz and the fourth intermediate frequency 112d is 8 MHz, and so forth. As the mixers 103 of the radiation sources 110 respectively only produce the sum signal from the radio frequency signal 113 and the transmitter intermediate frequency signals 112, the electromagnetic signals which are emitted by the antenna 104 and which illuminate the object 108 also have the same frequency spacings as the transmitter intermediate frequency signals.

In an alternative embodiment (not shown) the single-side-band mixers 103 respectively produce only the difference signal between the radio frequency signal 113 and the corresponding transmitter intermediate frequency signals 112. The only decisive consideration in that respect is that the mixers 103 do not produce two identical or overlapping frequencies and a unique association remains ensured in respect of the electromagnetic signals emitted by the radiation sources 110, with the individual radiation sources 110.

In a further embodiment (also not shown) two adjacent mixers 103 are supplied with the signal of a single intermediate frequency generator 102, wherein the first mixer 103 is a side-band mixer which only produces the difference frequency from the radio frequency signal 113 and the transmitter intermediate frequency signal while the second mixer 103 is a single-side-band mixer which only produces the sum frequency from the radio frequency signal and the transmitter intermediate frequency signal. In a further embodiment the antenna 103 of a first radiation source could also be fed directly with the radio frequency signal 113 while all other emitted signals are produced by mixing processes as in that case also unique associatability of the signals with the radiation sources 110 is possible, by way of the frequency of the emitted electromagnetic signals.

The intermediate frequency signals 112 produced by the signal generators 102 are detected by the computer 109 in order subsequently to permit an association of the individual received signals with the sources 110 upon detection. For that purpose the signal outputs of the generators 102 are connected to the computer 109.

The receivers 111 also shown in FIG. 2 are of a structure similar to the radiation sources 110. Each of the receivers 111 comprises a receiving antenna 105 and a mixer 106. The mixers 106 of the receivers 111 are respectively connected to the corresponding receiving antennas 105 and to the signal generator 101. The mixers 106 of the receivers 111 are single-side band mixers which form intermediate frequency signals with the difference frequency between the radio frequency signal 113 and the signals received by the receiving antennas 105.

Each of the receivers 111 has a detection bandwidth corresponding to the maximum frequency spacing of two transmitter intermediate frequency signals of the generators 102. As each of the receiving antennas 105 receives all signals emitted by the radiation sources 110 and those signals are mixed with the radio frequency signal 113 by the mixers 106 the receiver intermediate frequency signals 107a, 107b, 107c, 107d, . . . of all receivers 11 contain signal components at all frequencies of the transmitter intermediate frequency signals 112a, 112b, 112c, 112d, . . . insofar as they were transmitted through or reflected by the object 108 and have reached the corresponding receiving antennas 105. Each signal output 107a, 107b, 107c, 107d, thus contains a set of intermediate frequency signals which can be associated uniquely with one of the radiation sources 110.

The receiver intermediate frequency signals 107a, 107b, 107c, 107d, . . . are connected to the computer 109. The computer for each receiver 111 has a corresponding demultiplexer which makes it possible to break down each set of receiver intermediate signals, as it is produced by the respective receiver 111, into its spectral frequency constituents, and to evaluate same.

By means of the known algorithms for computing an image which was obtained with a synthetic aperture, a corresponding image of a column of the object 108, that corresponds to the focal line, is computed in the computer 109 from the receiver intermediate frequency signals 107a, 107b, 107c, 107d, . . . , and stored. That process is repeated for the various scanning positions of the focal line and optionally focal lengths. That information can be used to represent an image of the object for the user of the system on a display screen.

FIG. 3 shows an alternative embodiment to the arrangement of FIG. 1. The arrangement in FIG. 3 has an elliptical hollow-cylinder mirror 2′ which together with a plurality of mirrors 7′ forms an arrangement comprising primary mirror 2′ and secondary mirror 7′.

In this arrangement the row 1′ of radiation sources and receivers is arranged at the apex point of the hollow-cylindrical mirror 2′, that is to say at the point of the greatest spacing from the first focal point of the elliptical mirror. As previously described for the FIG. 1 embodiment the axis of the row 1′ is oriented parallel to the cylinder axis of the mirror 2′.

In the illustrated embodiment the secondary mirrors 7′ form the side surfaces of a prismatic body. That prismatic body is arranged rotatably about an axis of rotation 3′, wherein the rotation of the plurality of secondary mirrors 7′ in FIG. 3 replaces the pivotal movement of the overall arrangement of row 1 and mirror 2 in FIG. 1. The rotary movement of the plurality of secondary mirrors 7′ about the axis of rotation 3′ causes a pivotal movement of the focal line in the object plane 4′ along the direction 5′. The arrangement of a plurality of secondary mirrors 7′ on the prismatic body means that it is possible to increase the scanning speed at which the focal line scans the body disposed in the object plane 4′.

FIGS. 4a) through f) show different arrangements with a row 1, 1′ of radiation sources and receivers, hollow mirrors 2, 2′ and in the embodiments of FIGS. 4c) through f) additional secondary mirrors.

Although the arrangements in FIGS. 4a) through f) differ from each other and in part also from the arrangements in FIGS. 1 and 3 the elements are provided with identical references.

FIG. 4a) shows a plan view from above on to the arrangement shown in a three-dimensional view in FIG. 1. It can be clearly seen in this respect how a rotary movement of the row 1 and the elliptical cylindrical mirror 2 about the axis of rotation 3 causes a displacement of the focal line in a direction 5.

FIG. 4b) shows an alternative embodiment in which the pivotal movement of the arrangement of the mirror 2 and the row 1 is replaced by a lateral displacement of the row 1, that is to say a displacement in the direction of the row 1. Such displacement also causes lateral displacement of the focal line in the object plane and thus permits rastering of the object in one direction.

FIGS. 4c) through 4f) show arrangements in which the imaging optical means forms a telescope having a primary mirror 2′ and a secondary mirror 7′. Both the primary mirrors 2′ and also the secondary mirrors 7′ are cylindrical optical means each having a surface curved in one direction. The row 1′ of radiation sources and receivers is arranged in each case near the focal point of the telescope.

In FIG. 4c) the entire arrangement comprising the row 1′, the hollow-cylindrical primary mirror 2′ and the curved secondary mirror 7′ is reciprocatingly pivoted about an axis of rotation 3′ in order to scan the surface of an object with the focal line in the direction 5′.

As an alternative thereto in the arrangement of FIG. 4d) the row 1′ of radiation sources and receivers is reciprocated with a translatory movement parallel to the direction 5′ to cause lateral displacement of the focal line in the object plane.

Unlike the arrangement in FIG. 4d) in the arrangement in FIG. 4e) the secondary mirror 7′ is displaced in the direction 5′ in order in that way to cause lateral movement of the focal line over the object in the direction 5′.

FIG. 4f) shows an arrangement which is similar to the FIG. 3 embodiment and in which a plurality of secondary mirrors 7′ are rotated about an axis of rotation 3′ so that the object can be scanned at a high frequency. In contrast to the embodiment of FIG. 3 the secondary mirrors 7′ in the arrangement in FIG. 4f) have curved surfaces. In addition the individual secondary mirrors 7′ are at mutually different spacings from the axis of rotation 3′. In that way the focal length of the telescope comprising the primary mirror 2′ and the secondary mirrors 7′ is changed during a rotation of the prismatic body about the axis of rotation 3′ in discrete steps so that a synthetic increase in the depth of sharpness is achieved as the focal length is altered in discrete steps.

For the purposes of the original disclosure it is pointed out that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. A comprehensive explicit representation of all conceivable combinations of features is dispensed with here only for the sake of brevity and readability of the description.

While the invention has been described and illustrated in detail in the drawings and the preceding description that illustration and description is only by way of example and is not deemed to be a limitation on the scope of protection as defined by the claims. The invention is not limited to the disclosed embodiments.

Modifications in the disclosed embodiments are apparent to the man skilled in the art from the drawings, the description and the accompanying claims. In the claims the word ‘have’ does not exclude other elements or steps and the indefinite article ‘a’ does not exclude a plurality. The mere fact that certain features are claimed in different claims does not exclude the combination thereof. References in the claims are not deemed to be a limitation on the scope of protection.

1. Apparatus for imaging an object by means of electromagnetic very high frequency radiation comprising
at least two receivers for the very high frequency radiation, wherein the receivers are so arranged that they form a row,
a control which is so adapted that the receivers are so operable that they produce imaging with a synthetic aperture in a direction parallel to the row, and
an imaging optical means which is so adapted that it produces optical imaging only in planes substantially perpendicular to the row.

2. Apparatus as set forth in claim 1 wherein it has at least a first and a second radiation source for electromagnetic very high frequency radiation which together with the receivers are so arranged that they form a row of radiation sources and receivers.

3. Apparatus as set forth in claim 2 wherein the first radiation source is adapted to emit a first uniquely identifiable electromagnetic signal, wherein the second radiation source is adapted for emitting a second uniquely identifiable electromagnetic signal, and
wherein the two receivers are so adapted that each of them receives the first and second signals substantially simultaneously.

4. Apparatus as set forth in claim 1 wherein the imaging optical means has a cylindrical optical means.

5. Apparatus as set forth in claim 4 wherein the row of radiation sources and/or receivers is so arranged that it extends substantially parallel to the cylinder axis of the cylindrical optical means.

6. Apparatus as set forth in claim 4 wherein the cylindrical optical means has an elliptical base surface.

7. Apparatus as set forth in claim 1 wherein the row of radiation sources and/or receivers is arranged at a first focal point of the imaging optical means.

8. Apparatus as set forth in claim 4 wherein the cylindrical optical means is rotatable or pivotable about an axis parallel to its cylinder axis.

9. Apparatus as set forth in claim 1 wherein the imaging optical means has a hollow-cylindrical mirror forming a primary mirror and wherein the imaging optical means has a secondary mirror.

10. Apparatus as set forth in claim 1 wherein the row of radiation sources and/or receivers is arranged at the apex point of the base surface of the primary mirror.

11. Apparatus as set forth in claim 9 wherein the imaging optical means has a plurality of secondary mirrors arranged around an axis.

12. Apparatus as set forth in claim 9 wherein the secondary mirror is rotatable about an axis arranged substantially parallel to the row.

13. Apparatus as set forth in claim 1 wherein it has a device for altering the focal length of the imaging optical means.

14. Apparatus as set forth in claim 13 wherein the device for altering the focal length of the imaging optical means produces an alteration in at least one spacing between the row of radiation sources and receivers, the primary mirror or the secondary mirror.

15. Apparatus as set forth in claim 13 wherein the device for altering the focal length of the imaging optical means has a plurality, which is rotatable about an axis of rotation, of secondary mirrors which are so adapted that the spacings of the secondary mirrors from the axis of rotation are different from each other.

16. Apparatus as set forth in claim 13 wherein the device for altering the focal length of the imaging optical means has a plurality, which is rotatable about an axis of rotation, of secondary mirrors which have different radii of curvature.

17. A method of imaging an object by means of electromagnetic very high frequency radiation comprising the steps:
detecting the electromagnetic very high frequency radiation reflected or scattered by an object with at least two receivers, wherein the receivers are so arranged that they extend substantially in a single first direction in a row, and
evaluating the results of the receivers so that an image is produced with a synthetic aperture in the first direction,
imaging the electromagnetic very high frequency radiation prior to detection, wherein the imaging operation includes focusing of the electromagnetic radiation only in planes that are perpendicular to the first direction.

18. A method as set forth in claim 17 wherein it further comprises the steps:
emitting electromagnetic very high frequency radiation with at least a first and a second radiation source, wherein the radiation sources together with the receivers are so arranged that they extend substantially in a single direction in the form of a row, and
focusing the emitted electromagnetic very high frequency radiation with the imaging optical means on to an object.

19. A method as set forth in claim 18 wherein it further includes displacement or pivotal movement of the focal line of the emitted and focused electromagnetic very high frequency radiation in a direction perpendicular to the first direction.

20. A method as set forth in claim 17 wherein it further comprises a movement of an object in a direction perpendicular to the first direction.

21. A method as set forth in claim 17 wherein it further comprises a change in the focal length of the focusing.
